(19) United States
(12) Patent Application Publication
(10) Pub. No.: US 2026/0295898 A1
(43) Pub. Date: Oct. 1, 2026

(54) METHOD AND SYSTEM FOR 3D PRINTING ON A MOBILE PLATFORM

(71) Applicant: Zachary Todd Baldridge, Lynchburg, VA (US)

(72) Inventor: Zachary Todd Baldridge, Lynchburg, VA (US)

(21) Appl. No.: 19/441,919

(22) Filed: Jan. 7, 2026

Related U.S. Application Data
(60) Provisional application No. 63/780,164, filed on Mar. 28, 2025.

(51) Int. Cl. B28B 1/00; B28B 15/00; B28B 17/00; B33Y 10/00; B33Y 30/00; B33Y 40/00; B33Y 50/02

(52) U.S. Cl. CPC B28B 1/001; B28B 15/002; B28B 17/0081; B33Y 10/00; B33Y 30/00; B33Y 40/00; B33Y 50/02

(57) ABSTRACT

The present invention describes systems and methods for 3D printing, such as the 3D printing of concrete construction materials. In particular, the present invention relates to large-scale 3D printing of construction materials on a mobile platform.

### CROSS-REFERENCE TO RELATED APPLICATIONS

This application relies on the disclosure of and claims priority to and the benefit of the filing date of U.S. Provisional Application No. 63/780,164 filed Mar. 28, 2025, which is hereby incorporated by reference herein in its entirety.

### BACKGROUND OF THE INVENTION

### Field of the Invention

The present invention relates to the field of 3D printing of structural and/or non-structural components used in the construction of various structures, such as buildings. In particular, the present invention relates to large-scale 3D printing of construction materials, including cement-based structural and/or non-structural construction materials, on a mobile platform.

### Description of Related Art

The use of manufacturing systems, such as additive manufacturing systems comprising 3D printers, has expanded in recent years across many industries. For example, 3D printers have been employed in a variety of applications, e.g., medicine, automotive, aerospace, consumer goods, education, robotics, dentistry, fashion, jewelry, construction, etc., to print many different materials including biomaterials, cells, plastics, resin, metals, resins, powders, concrete, etc.

In construction, especially in the construction of commercial and residential structures and buildings, 3D printing can be used to create concrete three-dimensional structures in the preparation of a variety of construction components. One method of printing comprises 3D printing the concrete components at the work site. However, in this case, there are environmental restrictions, such as weather, humidity and temperature, which can hinder or limit the manufacturing process if not within a compatible range. For example, some concrete may set too slowly or not set at all at temperatures below 55° F. and may fail to cure or harden. At temperatures above 90° F., cement may set too quickly, compromising the 3D printed components and/or construction site workflow. As a result, year-round 3D printing on outdoor job sites is limited to warmer, drier climates and, in colder climates, 3D printing is not possible at certain times of the year and/or on days where the temperature and/or humidity conditions are not adequate for curing/hardening concrete pours. In addition, the 3D printers also need to be transported to the work site, where they must be set up, maintained, and then disassembled and transported to the next work site. This is both costly and inconvenient.

To combat adverse weather and temperature fluctuations, the concrete components can be printed in a climate-controlled setting, such as a factory. This method comes with its own challenges, especially in the context of 3D printing structural components for buildings. Challenges, such as unloading from the printing surface of the 3D printed concrete components—which components are often both heavy and large in size—may increase complexity of the build and/or disrupt construction site workflow. When produced in substantial quantities, such as is necessary when printing components of a home, unloading these components from the printing platform and transferring them to one or more vehicles increases manufacturing time and cost and increases the risk of damaging the components while loading or unloading and/or otherwise during transport. For example, an average 1800 square foot home may require sixty-five or more 3D printed components, production of which—depending on the size of the print surface—can require ten or more print sessions. Thus, a solution is needed to address the technical problems mentioned above.

### SUMMARY OF THE INVENTION

Aspect 1 is a system for manufacturing one or more 3D-printed components, the system comprising: at least one 3D print robot and a control unit for controlling 3D printing of the at least one 3D print robot; and a mobile platform on which the 3D printing by the at least one 3D print robot is performed; wherein the mobile platform loaded with the 3D printed structures is transportable to another location after the 3D printing is completed, without having to remove and reload the 3D printed structures from/onto the printing platform and/or another platform.

Aspect 2 is the system of Aspect 1, wherein the mobile platform comprises: a flat upper surface, typically horizontally oriented or substantially horizontally oriented with respect to the ground, on which the 3D printing of the 3D structures is performed; and, optionally, a heating mechanism for controlling a temperature of the flat upper surface, typically integrated into and/or in direct contact with the mobile platform, the flat upper surface and/or in contact with a surface that opposes the flat upper surface.

Aspect 3 is the system of Aspect 1 or 2, wherein the mobile platform is a pallet, shaped and sized to accommodate and/or support multiple 3D printed structural and/or non-structural building components, which is optionally configured for placement on and/or attachment to a trailer or conveyor system.

Aspect 4 is the system of any of Aspects 1-3, wherein the mobile platform is a trailer and further comprises: one or more sets of wheels disposed underneath a bottom side of the mobile platform; and a connection mechanism for detachably connecting the mobile platform to a vehicle, such as in a manner to enable towing capabilities of the mobile platform by the vehicle.

Aspect 5 is the system of any of Aspects 1-4, further comprising: a height adjusting mechanism for controlling a height of the flat upper surface of the mobile platform by lifting or lowering the mobile platform relative to the ground and/or relative to another component of the mobile platform. In embodiments, the height of the mobile platform and/or the flat upper surface of the mobile platform, is adjustable. In embodiments, the mobile platform comprises a height-adjustable flat upper printing surface which surface is capable of being lifted and/or lowered relative to wheels and/or other supports of the mobile platform.

Aspect 6 is the system of any of Aspects 1-5, further comprising: a heated substance and/or liquid (e.g., water, oil, air, gas, etc.) supply line for supplying heated liquid to and/or integrated into the heating mechanism of the mobile platform; wherein the heating mechanism comprises: a plurality of pipes and/or tubing and/or containers disposed below the flat upper surface of the mobile platform and in direct or indirect contact therewith to conduct heat from the heated substance and/or liquid supply line(s) to the flat upper printing surface. In embodiments, the plurality of pipes and/or tubing and/or containers are configured to receive heated liquid from the heated liquid supply line; an output line connected to the plurality of pipes and/or tubing and/or containers and configured to drain the heated substance and/or liquid after use; and optionally, a temperature sensor for determining the temperature of the upper flat surface of the mobile platform and/or the temperature of the heated substance and/or liquid and/or the temperature of the plurality of pipes and/or tubing and/or containers supplying the heated substance and/or liquid.

Aspect 7 is the system of any of Aspects 1-6, further comprising a conveyor system on which the mobile platform can be placed, wherein the mobile platform can be transported from a 3D printing location within the vicinity of the 3D print robot to another location by the conveyor system after the 3D printing is completed and without having to remove and reload the 3D printed structures from/onto the flat upper surface/mobile platform and/or another platform/surface and/or intermediate location.

Aspect 8 is a mobile platform on which 3D printing of one or more 3D-printed components can be performed by one or more 3D print robots, the mobile platform comprising: a flat upper surface, typically horizontally oriented or substantially horizontally oriented with respect to the ground, on which the 3D printing is performed; a heating mechanism for controlling a temperature of the flat upper surface, typically integrated into and/or in direct contact with the mobile platform, the flat upper surface and/or in contact with a surface that opposes the flat upper surface; one or more sets of wheels disposed underneath a bottom side of the mobile platform; and a connection mechanism for detachably connecting the mobile platform to a vehicle, such as in a manner to enable towing capabilities of the mobile platform by the vehicle; wherein the heating mechanism comprises: tubing and/or a plurality of pipes and/or one or more containers disposed below the flat upper surface and configured to receive heated water/substance from a heated water/substance supply line; an output line connected to the tubing and/or the plurality of pipes and/or containers and configured to drain the heated water after use; and a temperature sensor for determining the temperature of the upper flat surface of the mobile platform and/or the temperature of the heated substance and/or liquid and/or the temperature of the plurality of pipes and/or tubing and/or containers supplying the heated substance and/or liquid.

Aspect 9 is a method of manufacturing and transporting numerous concrete structural and/or non-structural components used for building construction, the method comprising: transporting a mobile platform (according to any embodiment described herein) on which 3D printing of 3D structural and/or non-structural building components is performed to a 3D printing location in the vicinity of a 3D print robot, the mobile platform comprising a flat upper surface (according to any embodiment described herein) on which the 3D printing is performed and a heating mechanism (according to any embodiment described herein) for controlling a temperature of the flat upper surface and/or the mobile platform or a component or surface thereof, adjusting a temperature of the mobile platform via the heating mechanism, such as in a manner to manipulate and/or control the curing speed (such as to increase or decrease the speed of curing), capability and/or quality of the 3D printed concrete structures; 3D printing the concrete components/structures onto the flat upper surface of the mobile platform; and transporting the mobile platform to a construction site with the 3D printed concrete components without having to remove and/or reload the 3D printed structures from/onto the printing surface/mobile platform and/or another surface/platform and/or intermediate location.

### BRIEF DESCRIPTION OF THE DRAWINGS

The accompanying drawings illustrate certain aspects of implementations of the present disclosure and should not be construed as limiting. Together with the written description the drawings serve to explain certain principles of the disclosure.

FIG. 1 is a diagram showing a top plan view of a 3D printing system comprising a mobile printing platform/trailer, according to embodiments of the invention.

FIG. 2 is a diagram showing a side elevation view of a 3D printing system comprising a mobile printing platform/trailer, according to embodiments of the invention.

FIG. 3 is a diagram showing a top plan view of a 3D printing system comprising a mobile printing platform and conveyor/roller system, according to embodiments of the invention.

FIG. 4 is a diagram showing a side elevation view of a 3D printing system comprising a mobile platform and conveyor/roller system, according to embodiments of the invention.

### DETAILED DESCRIPTION OF VARIOUS EMBODIMENTS OF THE INVENTION

Exemplary embodiments have been disclosed herein and in the drawings. Although specific terms have been used herein, the terms are only used for the purpose of describing the present disclosure and are not intended to limit meanings or limit the scope of the present disclosure. Therefore, those of ordinary skill in the art should understand that various modifications and other equivalent embodiments are possible.

The 3D printing system of the present invention may be configured for indoor and/or outdoor use. In embodiments, the system is configured for use in a setting in which one or more environmental conditions can be controlled, such as but not limited to indoor use. In embodiments, the environmental conditions can include, but are not limited to, temperature, humidity, carbon dioxide level, and/or any other desired conditions, such as one or more conditions capable of affecting the printing capabilities, such as flow rate, and/or the curing process of the printed material, such as cement-based material.

In an embodiment of the invention, the 3D printing system comprises one or more 3D printer comprising one or more print robot configured to move in one or more direction, including x-, y-, and/or z-directions and, optionally, one or more rotational axis.

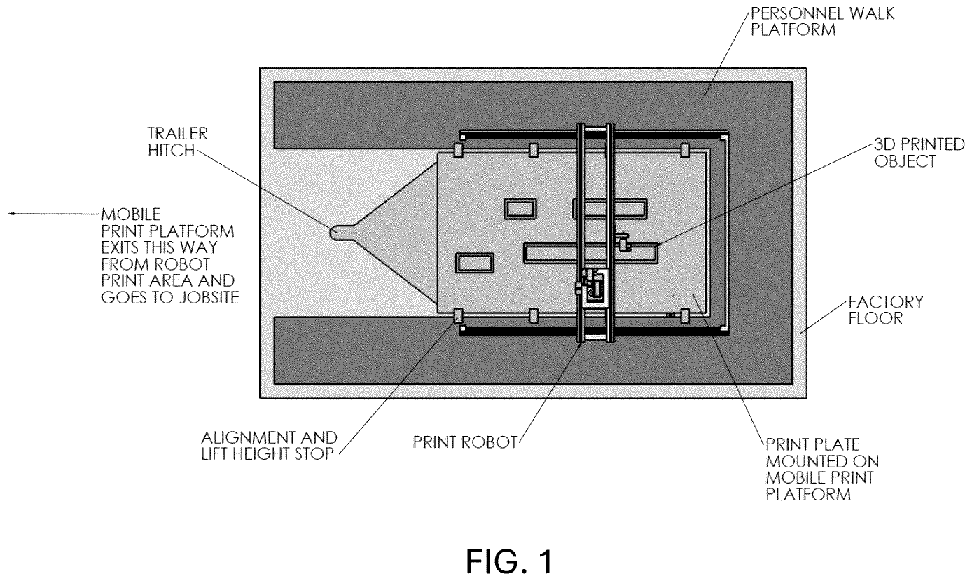

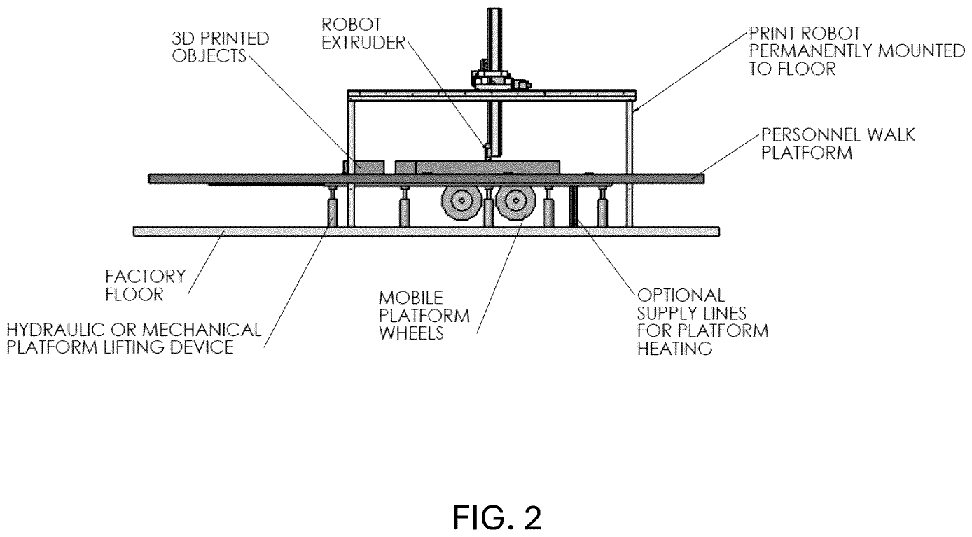

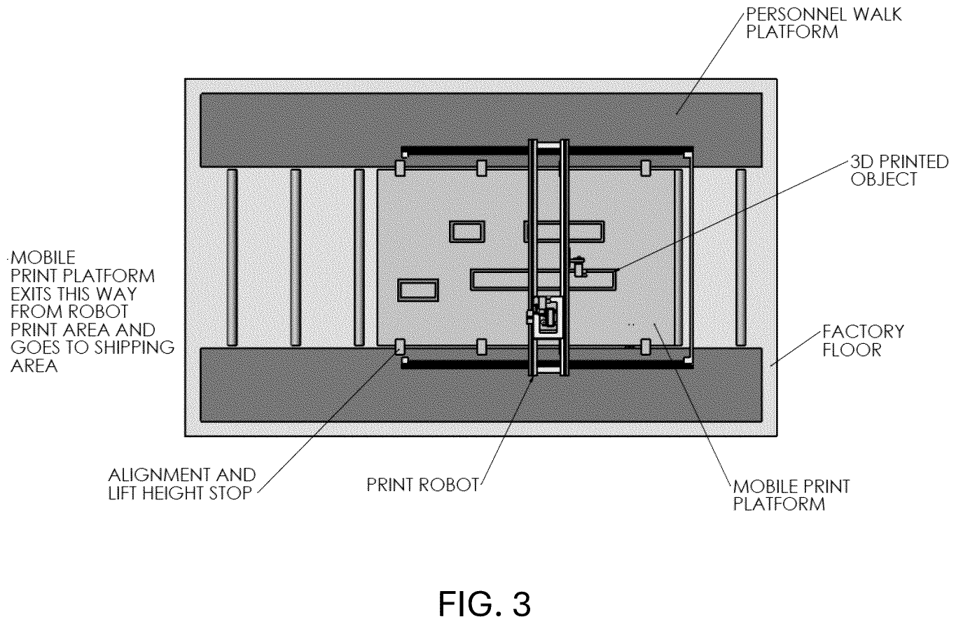

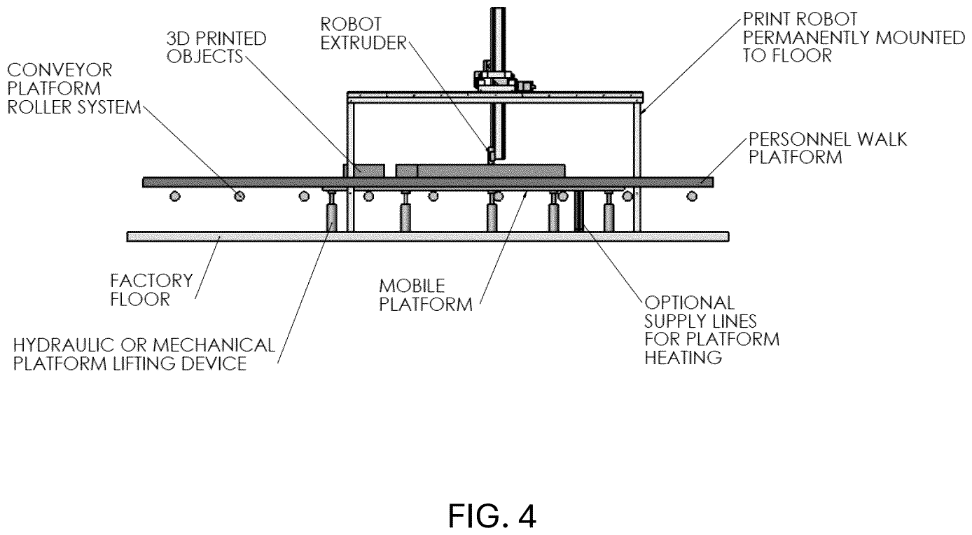

The 3D printing system can be configured to print on a variety of printing surfaces. In embodiments, the printing surface, such as a flat upper surface, is a surface of a mobile platform, such as a trailer, or a print plate. In embodiments, a print plate is mounted on a mobile platform and/or a trailer comprising printing platform, such as a flat upper surface. In embodiments, the mobile platform is a mobile trailer (FIGS. 1-2) or printing platform positioned on a conveyor belt or roller system (FIGS. 3-4).

The mobile platform may be moved into a manufacturing/3D printing area located underneath one or more 3D printers of the 3D printing system. After the mobile platform is positioned roughly in the correct location, a lifting apparatus, such as a hydraulic or mechanical lifting device, may be used to raise the mobile platform, mobile trailer, or printing platform off of the ground and/or relative to another component of the mobile platform/trailer/printing platform such as wheels. In embodiments, the mobile platform is lifted into a metal alignment frame that guides it into the proper position. The frame can have any number of sides, such as 1, 2, 3 or 4, in one or more planes, such as 1, 2, 3, or more planes. For example, the platform can be positioned and/or lifted to a point where one side of the mobile platform/trailer is aligned with one or more sides of a guide frame or guide rail. In embodiments, the mobile platform/trailer is aligned with two opposing rails or sides. In embodiments, the rails and/or sides are adjustable to position the mobile platform/trailer in a desired position to receive printed material from the 3D print robot and can be adjusted to push, pull, slide, lift and/or rotate the mobile platform/trailer into the desired position, for example, under the print head of the 3D print robot/printer.

In embodiments, the system is configured to align the 3D printer with the print platform using one or more manual or automatic alignment system, optionally comprising one or more sensors such as one or more camera(s), such as for use with a camera vision-based alignment system. In embodiments, the alignment system can operate to move the 3D printer/robot and/or print head to a desired print location relative to the mobile platform/trailer and/or the alignment system can operated to move the mobile platform/trailer to a desired print location relative to the 3D printer/robot and/or print head. The alignment can take place at anytime before, during and/or after printing on the mobile trailer/platform.

In embodiments, the system user manually confirms the location of the mobile platform prior to, during and/or after printing and registers the location of the mobile platform/trailer with the 3D printing system, such as by entering or confirming the location in a software program. In embodiments, the location of the mobile platform/trailer can be confirmed manually by the user prior to, during and/or after printing to register the location of the mobile trailer/platform with the 3D printing system, such as by entering or confirming the location in a software program.

In embodiments, the lifting apparatus is configured to adjust the height of the mobile platform and/or trailer before, during or after printing. In embodiments, the lifting apparatus is configured to adjust the height of the mobile platform before and/or after printing. In embodiments, the lifting apparatus is configured to raise and/or lower the mobile platform up to several feet, such as up to 1 inch, 2 inches, 3 inches, 4 inches, 5 inches, 6 inches, 9 inches, 12 inches, 18 inches, 2 feet, 3 feet, 4 feet, 6 feet, or more from the ground. In embodiments, the lifting apparatus is configured to adjust the height of the flat upper surface of the mobile platform/trailer up and/or down relative to another component of the mobile platform/trailer, such as relative to the wheels.

Alternatively, the trailer does not need to be elevated. In embodiments, the one or more 3D printers may be height adjustable to be positioned to extrude and/or print the printing material and 3D print the components on the mobile platform, such as the deck of a trailer, or a print plate attached to and/or otherwise disposed on a trailer.

The printing surface, mobile platform, print plate, and/or conveyor or roller system may optionally comprise one or more heating system(s) (FIGS. 2 and 4) which is used to control, adjust, and/or maintain the temperature of the surface on which the 3D printing occurs. In embodiments, the heating system comprises one or more component capable of providing radiant heat, such as radiant electric heating, infra-red heating, resistance heating mats, or tubes and/or pipes and/or containers for liquid and/or forced air heating. In embodiments, the heating system may include one or more supply line configured to attach to the printing surface (such as the flat upper surface of the mobile platform/trailer), the mobile platform, the print plate, and/or the conveyor or roller system. In embodiments, the heating system comprises an array or plurality of tubes/pipes/containers located on the underside of the printing surface, mobile platform, print plate, and/or conveyor or roller system (and in direct or indirect contact therewith to conduct heat to or to otherwise heat the printing surface) and, once in correct position for 3D printing, hot water/oil/substance may be introduced into the tubes/pipes/container via an inlet. The hot water lines may be connected to the main factory hot water system. The flow of heated water/oil/substance will begin circulating beneath the printing surface. This heating will heat the printing surface to a desired temperature. Once the surface temperature and/or the temperature of the water/oil/substance meets the desired conditions, the 3D printer above it will begin its process of extruding and printing the material directly onto the printing surface. In embodiments, the system comprises a cooling system, such as a cooling system configured as described for the above heating system, wherein the water/oil/substance introduced into the tubes/pipes/container is cool, relative to the printing environment.

This process will continue until the printing of the components in part or whole is complete. In embodiments, the printer is capable of printing cement-based material (comprising 10-30 wt % cement, 40-80 wt % aggregates, and 5 -25 wt % water) at a printing rate in the range of 500-5,000 pounds per hour, such as about 750 pounds/hr, or about 1,000 lbs/hr, or about 1,500 lbs/hr, or about 2,000 lbs/hr, or about 2,500 lbs/hr, or about 3,000 lbs/hr, or about 3,500 lbs/hr, or about 4,000 lbs/hr or about 4,500 lbs/hr. Additionally or alternatively, the printer is capable of printing cement-based material (comprising 10-30 wt % cement, 40-80 wt % aggregates, and 5 -25 wt % water) at a printing rate of 1-12 inches/second, such as at a rate of about 1.5 inch/second, or about 2 inches/second, or about 2.5 inches/second, or about 3 inches/second, or about 3.5 inches/second, or about 4 inches/second, or about 4.5 inches/second, or about 5 inches/second, or about 5.5 inches/second, or about 6 inches/second, or about 6.5 inches/second, or about 7 inches/second, or about 7.5 inches/second, or about 8 inches/second, or about 8.5 inches/second, or about 9 inches/second, or about 9.5 inches/second, or about 10 inches/second, or about 10.5 inches/second, or about 11 inches/second or about 11.5 inches/second. Alternatively or in addition, the printer is capable of printing cement-based material (comprising 10-30 wt % cement, 40-80 wt % aggregates, and 5 -25 wt % water) at a printing rate of 0.25 -2 ft²/s, such as about 0.3 ft²/s, such as about 0.4 ft²/s, such as about 0.5 ft²/s, such as about 0.6 ft²/s, such as about 0.7 ft² /s, such as about 0.75 ft²/s, such as about 0.8 ft²/s, such as about 0.9 ft² /s, such as about 1 ft² /s, such as about 1.25 ft²/s. In embodiments, the printer is capable of printing cement-based material overnight and/or during daylight hours. In embodiments, the printer is capable of being supplied/fed cement-based print material by way of a hopper and/or a cement mixer. In embodiments, the printer is capable of printing one or more layers of one or more cement-based structural and/or non-structural building components simultaneously, layer by layer until the desired number of layers is achieved for one or more or all of the cement-based structural and/or non-structural building components. In embodiments, multiple structural and/or non-structural building components are capable of being printed in a manner such that one component comprising a number of layers is complete while printing continues to print one or more other component comprising a larger number of layers. In embodiments, the non-structural components are optionally chosen from architectural details (benches, decorative curtain wails, and/or other non-structural elements). In embodiments, the 3D printed structures are structural and/or non-structural components for use in businesses, hotels, theme parks, ocean seawalls, etc.

Once the print is complete, and optionally after a delay, the mobile platform or print plate, such as the mobile trailer, will be lowered back to the ground (if needed) and removed from the area beneath the 3D printing system without having to remove and/or reload the 3D printed structures from/onto the printing surface/mobile platform and/or another surface/platform and/or intermediate location. In embodiments, the mobile trailer may be towed away to a construction site to deliver the printed components without having to remove and/or reload the 3D printed structures from/onto the printing surface/mobile platform and/or another surface/platform and/or intermediate location. After the first mobile platform or printing plate is moved out, a second mobile platform or printing plate may be brought in to be positioned for a second printing job. In embodiments, the delay between printing completion and removal of the print platform or print plate from the 3D printing system, which delay allows the print material to begin the curing process, is at least 1 hour, such as at least 1.5 hours, 2 hours, 2.5 hours, 3 hours, 3.5 hours, 4 hours, 4.5 hours, 5 hours, 6 hours, 7 hours, 8 hours, 9 hours, 10 hours, 11 hours, 12 hours, 13 hours, 14 hours, 15 hours, 16 hours, 17 hours, 18 hours, or more. Such a delay is beneficial to enable the 3D printed structural and/or non-structural components to set/cure sufficiently before being transported to another location to avoid disturbing the setting/curing process and potentially damaging the 3D printed structures.

In another embodiment of the present disclosure, the 3D printing may occur on one or more platens/pallets which are disposed on top of a conveyor system. The 3D printer may extrude the print materials to 3D print the desired components onto the printing surface, such as one or more platens/pallets, which are then transported via the conveyor belt or roller system to a desired mode of transport, such as a truck or a trailer.

In embodiments, the 3D printing system is configured to print one or more material. In embodiments, the one or more print material is a concrete-based printing material, such as a hydraulic cement or non-hydraulic cement. In embodiments, the printing material comprises one or more of: water, one or more binder (such as cement), one or more aggregates (such as sand, gravel, stone, etc.), one or more water reducer, one or more accelerator (such as calcium chloride, calcium formate, calcium nitrate, etc.), colorant (such as a concrete-compatible pigment), limestone, clay, one or more mineral, mineral oxide, and/or mineral hydrate (such as calcium, magnesium, etc.), or combinations thereof. In embodiments, the print material is clay-or ceramics-based, foam-based (such as expanding foam), or metal-based (such as via metal deposition, wire arc additive manufacturing).

In embodiments, the print material primarily comprises cement, one or more aggregates, and water. In embodiments, the print material before printing comprises about 10-30 wt % cement, about 40-80 wt % aggregates, and about 5 -25 wt % water. In embodiments, up to about 15 wt % of the print material before printing comprises one or more admixture(s), such as admixture(s) comprising one or more material disclosed herein. For example, specific embodiments of the print material before printing may comprise 10 wt %, 15 wt %, 20 wt %, 25 wt % or 30 wt % cement in combination with 40 wt %, 45 wt %, 50 wt %, 55 wt %, 60 wt %, 65 wt %, 70 wt %, 75 wt % or 80 wt % aggregates in combination with 5 wt %, 10 wt %, 15 wt %, 20 wt % or 25 wt % water, optionally in combination with up to 0.5 wt % or about 1-3 wt %, 2-5 wt %, 4-6 wt %, 5-7 wt %, 6-10 wt %, 7-11 wt %, 8-12 wt % or 9-15 wt % admixture(s). Embodiments of the present disclosure enable efficient manufacturing of concrete components used in construction, such as components prepared within a climate-controlled environment, as well as efficient transport of the printed 3D concrete components to the construction site.

### Example

A flatbed trailer is positioned beneath a 3D printing system in an indoor workspace capable of temperature and/or humidity control. The flatbed trailer is positioned (along the x-axis and y-axis), such that it is proximate to and/or in contact with an alignment frame/rail. The flatbed trailer is then lifted several inches or more from the floor/ground by a lifting apparatus. The flatbed trailer is lifted within the alignment frame and/or is lifted, rotated and/or is slid to abut the alignment frame/rail, which frame guides the position of the trailer along the (z-axis) until it meets a vertical stop and/or along the x-or y-axis until the trailer is in a desired x/y/z position under the print robot. The flatbed trailer is then optionally locked into place relative to or within the alignment frame.

The printing surface is then optionally heated or cooled to a desired temperature and the printer is primed when the printing material is mixed and pushed through the 3D printer's extrusion system. Once this priming process is complete, the print file provided to the 3D printing system is used to guide printing. The printer and pump system push material through a hose and print nozzle onto the flatbed trailer, one layer at a time. After each layer, the 3D printer raises the extrusion nozzle along the z-axis before beginning the next layer.

The 3D printing system prints up to 80 layers over a period of approximately 10 hours and dispenses approximately 21,000 pounds of print material onto the flat upper surface of the mobile trailer/platform. Upon completion of the final layer, the final layer is shaved flat using a leveling tool. After approximately 12 hours, the flatbed trailer is lowered from the alignment frame and a second flatbed trailer is positioned within the alignment frame to begin the next print job.

Throughout this specification, when a part is referred to as being “connected” to another part, this includes “direct connection” and “indirect connection” via an intervening part. Also, when a certain part “includes” a certain component, other components are not excluded unless explicitly described otherwise, and other components may in fact be included. Moreover, in describing elements of the present disclosure, terms such as first, second, A, B, (a), (b) and others may be used. Such terms are used only for purposes of distinguishing an element from other elements, but do not limit the substance of the element, sequence, or order.

All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure. No language in the specification should be construed as indicating any non-claimed element as essential to the practice of the disclosure.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the compositions disclosed herein or with any other compositions. Likewise, any of the disclosed compositions can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The term “about” used herein in the context of quantitative values or measurements means the indicated amount ±10%. For example, with a ±10% range, “about 2 mg” can mean 1.8-2.2 mg.

The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A system for manufacturing one or more 3D-printed components, the system comprising:
at least one 3D print robot and a control unit for controlling 3D printing of the at least one 3D print robot; a mobile platform on which the 3D printing by the at least one 3D print robot is performed;
an alignment frame comprising a vertical stop; and
a height adjusting mechanism configured to raise and lower the mobile platform;
wherein the mobile platform is transportable to another location after the 3D printing is completed; and
wherein the height adjusting mechanism is capable of raising and/or lowering 21,000 lbs of print material.

2. The system of claim 1, wherein the mobile platform comprises:
a flat upper surface on which the 3D printing is performed; and
a heating mechanism for controlling a temperature of the flat upper surface.

3. The system of claim 2, wherein the mobile platform is a trailer and further comprises:
one or more sets of wheels disposed underneath a bottom side of the mobile platform;
a connection mechanism for detachably connecting the mobile platform to a vehicle.

4. (canceled)

5. The system of claim 2, further comprising: a heated water supply line for supplying heated water to the heating mechanism of the mobile platform,
wherein the heating mechanism comprises:
a plurality of pipes and/or containers disposed below the flat upper surface of the mobile platform and configured to receive heated water from the heated water supply line;
an output line connected to the plurality of pipes and/or containers and configured to drain the heated water after use; and
a temperature sensor for determining the temperature of the upper flat surface of the mobile platform.

6. The system of claim 1, further comprising a conveyor system on which the mobile platform is disposed,
wherein the mobile platform is transported from a 3D printing location to another location by the conveyor system after the 3D printing is completed.

7. A mobile platform on which 3D printing of one or more 3D-printed components is performed by one or more 3D print robots, the mobile platform comprising:
a flat upper surface on which the 3D printing is performed;
optionally, a heating mechanism for controlling a temperature of the flat upper surface;
one or more sets of wheels disposed underneath a bottom side of the mobile printing platform; and
a connection mechanism for detachably connecting the mobile platform to a vehicle,
wherein, optionally, the heating mechanism comprises:
a plurality of pipes and/or containers disposed below the flat upper surface and configured to receive heated water from a heated water supply line;
an output line connected to the plurality of pipes and/or containers and configured to drain the heated water after use; and
a temperature sensor for determining the temperature of the upper flat surface of the mobile platform; and
wherein the mobile platform is capable of supporting 21,000 lbs of print material.

8. A method of manufacturing and transporting numerous concrete components used for construction, the method comprising:
transporting a mobile platform on which 3D printing is performed to a 3D printing location comprising an alignment frame, the mobile platform comprising a flat upper surface on which the 3D printing is performed;
using a lifting apparatus, lifting the mobile platform within the alignment frame until it meets a vertical stop;
3D printing multiple concrete components onto the flat upper surface of the mobile platform;
lowering the mobile platform for transport; and
transporting the mobile platform to a construction site with the multiple 3D printed concrete components.

9. The method of claim 8, wherein the mobile platform comprises a heating mechanism for controlling a temperature of the flat upper surface of the mobile platform and further comprising adjusting the temperature of the flat upper surface via the heating mechanism.

10. The method of claim 8, further comprising, after 3D printing is complete, leveling the top layer of printed material using a leveling tool.

11. The method of claim 8, further comprising a delay of at least 1 hour between completion of 3D printing and lowering the mobile platform for transport.

12. The method of claim 8, further comprising a delay of 1-12 hours between completion of 3D printing and lowering the mobile platform for transport.

13. The method of claim 8, wherein the lifting apparatus and mobile platform are capable of supporting 21,000 lbs of print material.

14. The method of claim 8, wherein the 3D printed concrete components remain on the mobile platform until delivery to the construction site.

15. The method of claim 8, wherein at least one of the 3D printed concrete components comprises 80 layers of print material.

16. The method of claim 11, further comprising, after 3D printing is complete, shaving the top layer of printed material such that it is parallel to the mobile platform using a leveling tool.

17. The method of claim 16, further comprising a delay of at least 1 hour between completion of 3D printing and lowering the mobile platform for transport.

18. The method of claim 17, wherein the lifting apparatus and mobile platform are capable of supporting 21,000 lbs of print material.

19. The method of claim 18, wherein the 3D printed concrete components remain on the mobile platform until delivery to the construction site.

20. The method of claim 19, wherein the delay between completion of 3D printing and lowering the mobile platform for transport is at least 12 hours.

21. The system of claim 1, wherein the system further comprises at least one additional mobile platform.
